(19) United States
(12) Patent Application Publication
(10) Pub. No.: US 2008/0213149 A1
(43) Pub. Date: Sep. 4, 2008

(54) Process for producing steam and/or power from oil residues

(76) Inventor: Richard Gauthier, Longueuil (CA)

Correspondence Address: Franz BONSANG;c/o EQUINOX PROTECTION, 410 - 1500, Du College, St-Laurent, QC, H4L 5G6, CA

(21) Appl. No.: 12/078,972

(22) Filed: Apr. 9, 2008

Related U.S. Application Data
(63) Continuation-in-part of application No. 11/199,127, filed on Aug. 9, 2005.
(60) Provisional application No. 60/599,575, filed on Aug. 9, 2004.

(51) Int. Cl. B01D 53/56; B01D 53/50

(52) U.S. Cl. 423/239.1; 423/235

(57) ABSTRACT

Power is produced using fuel from raw and/or preprocessed oil residues which are burned alone, without any addition of sorbents, diluents or the like, to generate high pressure steam and/or power and residual emissions. Residual emissions are cleaned to simultaneously remove PM, NO_{X} and SO₂ therefrom. The sulfur in emissions can be used to produce sulfuric acid. The process uses a low cost fuel, generates steam, and/or power and sulfuric acid and meets all emission requirements for PM, NO_{X} and SO₂.

### CROSS REFERENCE TO RELATED APPLICATIONS

The present application is a Continuation-In-Part (C.I.P.) of U.S. patent application Ser. No. 11/199,127 filed on Aug. 9, 2005, now abandoned, and which claimed priority on U.S. Provisional Application for Patent Ser. No. 60/599,575 filed on Aug. 9, 2004.

### FIELD OF THE INVENTION

This invention relates to a clean process for producing steam and/or power from raw and/or preprocessed oil residues.

More specifically, the invention relates to an integrated process in which raw and/or preprocessed oil residues are burned alone, without any addition of sorbents or the like, as fuel to generate steam and/or power, as well as residual emissions that are cleaned by simultaneously removing PM (particulate materials), NO_{X}, and SO₂ therefrom.

### BACKGROUND OF THE INVENTION

Since Canadian conventional oil production is dwindling and both synthetic crude and bitumen production are on the rise there is a need to reduce the energy costs of bitumen production and the use of expensive diluents for transporting bitumen to refineries by pipeline.

As conventional oil deposits dwindle, upgradable fuel derived therefrom has become increasingly more expensive to produce. The search for inexpensive fuel sources is an on-going problem. Bitumen or tar sand deposits (oil sands) found in areas of Western Canada such as the Athabasca, Cold Lake and Peace River areas of Alberta, and other places in the world (Venezuela, U.S.A., China, Russia) represent a largely unused source of raw crude oil, typically in the form of bitumen. The bitumen is produced from either oil sands (surface mines) or “in situ” by steam assisted gravity drainage “SAGD”, cyclic steam stimulation “CSS” and other production techniques using steam. The bitumen from oil sands or in situ production includes a mixture of maltenes, aromatics, resins and asphaltene compounds in varying amounts, the least valuable component being the asphaltenes. Extracting bitumen from oil sands and other deposits is difficult and requires hot water or steam injection to liquefy the high viscosity bitumen for transport to a surface processing plant. The process of steam production requires continuous use of often expensive fuels and thus an inexpensive, readily available fuel is highly desirable.

Several processes have been described addressing the above-identified problems including those described, e.g. in U.S. Pat. Nos. 6,536,523; 6,524,469; 6,511,937; 6,357,526; 5,958,365; 5,055,029; 4,755,278; 4,634,520; 4,283,231; 4,042,027; 4,036,732 and 3,779,902.

The processes described in the prior art suffer from a number of important drawbacks. The processes are complex, involving multiple separate steps, which are not fully integrated. Moreover, the processes involve pre-treating the bitumen which may be expensive, requiring many reagents and diluents, specialized equipment and prior manipulation of the crude bitumen. None of the processes offers an affordable solution to the reduction of production costs of heavy oil producers who rely on expensive fuel such as natural gas to generate the high pressure steam needed to extract the low viscosity bitumen found in different remote places such as in the Athabasca region of Alberta, Canada. Existing processes do not meet the need for reduced fuel and diluents dependency in the production of a partially upgraded bitumen stream and a precipitate of asphaltenes. Asphaltenes are low value hydrocarbons useful as a fuel in the field. The removal of the heavier portions of the bitumen does improve the viscosity of the de-asphalted oil and accordingly a much lower amount of expensive diluents is needed to make the produced bitumen pipelinable to the market. Finally, prior art was not addressing the need of reducing air emissions, greenhouse gas emissions and the need to improve efficiency of the process and reduce waste.

Thus there is a need for an improved process for generating fuel from raw and/or preprocessed oil residues to reduce energy cost, waste and the use of expensive diluents.

### SUMMARY OF THE INVENTION

Accordingly, the present invention relates to a clean process for producing steam and/or power and using fuel from raw and/or preprocessed oil residues comprising the steps of: burning, or combusting, alone the oil residues as a fuel to generate high pressure steam, or power and residual emissions; and cleaning the residual emissions to generally and simultaneously (essentially at the same time, although chemically in sequential order, in an essentially same location, same plant) remove PM, NO_{X} and SO₂ therefrom.

More specifically, the invention may relate to an integrated process in which heavy oil or bitumen produced from both “in situ” or surface oil sands mines is solvent de-asphalted to yield a de-asphalted oil (DAO) and an asphaltene fraction, which is used as fuel in a boiler to replace expensive natural gas, reduce energy costs and reduce or obviate the need for diluents to make the de-asphalted oil pipelinable. In particular the invention will substantially reduce energy and diluents costs and improve the economics of producing bitumen. In addition, produced de-asphalted oil will be of higher quality, lower viscosity, reduced sulfur, nitrogen, Conradson carbon, nickel and vanadium.

The inventor found that any raw and/or preprocessed oil residues such as, but not limited to, unprocessed bitumen (from both from oil sands and “in situ”” processes can be efficiently de-asphalted to produce higher quality de-asphalted oil and asphaltenes which can be used as a liquid or solid fuel for producing steam (and/or power) in a clean, or ‘green’, way. The bitumen, typically from parafinic process or naphta-based process, is merely dehydrated and desalted, flashed to remove the gas oil fraction and then de-asphalted. The process is cost effective and produces high quality fuel, that is of higher BTU (British Thermal Unit) content than coal or pet (petroleum) coke with lower amounts of ash than coal. These characteristics make asphaltenes an ideal fuel to be transported in solid form as granules, or in hot liquid form, or as a water/oily slurry or as a water or oil emulsion. Moreover, fluidized bed boiler, BFD (bubbling fluidized bed), CFB circulating fluidized bed or OTSG (once through steam generating) CFB boilers or OTSG boiler with FGD (flue gas desulphurization) units burn asphaltenes in a clean manner and generate much less emissions than coal. Moreover, the boiler(s) is used with a residual emissions cleaning unit such as a sulfuric acid plant (such as a WSA™ process) or preferably with a SNOX™ unit for simultaneously cleaning emissions of SO₂, NO_{X} and PM while producing commercial grade sulfuric acid. Removing PM, NO_{X} and SO₂ in the gas phase after combustion has additional benefits: reduced needs for sulfur sorbents, reduced production of ashes and gypsum, improved thermal efficiency of boiler. In addition the removal of pollutants allows for the production of sulfuric acid (H₂SO₄) of commercial grade; the most common and basic chemical.

Moreover, the process is fully integrated and can be used on site without the need for additional processing units. Since the process uses raw, or preprocessed oil residues, it significantly decreases costs by reducing the amount of pretreatment with organic solvents. The process of the present invention significantly improves oil quality, and significantly lowers oil viscosity thereby permitting easier pumpability of the oil through standard pipelines. Organic and inorganic contaminants are reduced in the oil which improves the value of the de-asphalted oil.

In accordance with the present invention, there is provided a clean process for producing steam and/or power and using fuel from raw and/or preprocessed oil residues, comprising the steps of burning alone the oil residues as a fuel to generate high pressure steam, and/or power and residual emissions; and cleaning the residual emissions to simultaneously and generally remove PM, NO_{X} and SO₂ therefrom.

The burner, such as any type of boiler is used to generate high pressure steam that will typically first go through a steam turbine to generate electricity and preferably process steam for a SAGD, CSS or low pressure oil sand process.

Once through the turbine, the steam can be extracted at a back pressure (conventionally called process pressure) needed for use in a SAGD, CSS or OILSANDS or other steam extraction process which may be developed in the future.

The asphaltenes fraction can be used as a hot liquid in the combustion process or alternatively can be pelletized for storage, transport or use as a solid fuel in the combustion step. Alternatively, hot liquid asphaltenes can be mixed with various surfactants and solvents to obtain a liquid fuel similar to bunker “C” fuel or residual fuel that can be stored, transported, pumped and used in the combustion process. The process can use any type of raw and/or preprocessed oil residues such as any crude bitumen, asphaltenes, tar sand deposits (oil sands), slurry oil, coal, bottom of the barrel residues or petroleum coke stored on the site of oil sands mines as fuels for boilers. Logistics and costs will dictate which fuel or combination to be used, because fluidized bed boilers or some other boilers are fuel flexible.

For example, fluidized bed boilers can be replaced by downshot boilers if petroleum coke is used as fuel, or pitch boilers if the asphaltenes stream is used as fuel. In both cases, a sulfuric acid and denox plant to remove PM, SO₂ and NO_{X} is required to meet emission requirements.

Alternatively, steam can be used directly in SAGD, CSS pads without the need to co-generate power.

Typically, instead of producing gypsum as in conventional CFB boiler using limestone or lime sorbents, the residual emissions are processed through a sulfuric acid plant or sulfuric acid and denox unit or the like process to remove sulfur from the back end. The benefits are reduced cost for limestone, higher thermal efficiency and better emissions, since 95-98% of both SO₂ and NO_{X} are removed. Prior processes failed to include the production of sulfuric acid as an efficient way to meet emissions requirement for SO₂, NO_{X} and PM. The use of a sulfuric acid plant at the back end allows for higher thermal efficiency of the boiler, no or reduced need for limestone and consequent production of gypsum. In Northern Alberta transportation costs are high, the use of limestone is expensive and production of gypsum increase costs. The production of marketable sulfuric acid disposes of sulfur in the most economical and permanent manner. No stockpiles of sulfur or gypsum will be created as a result of this invention. The use of a sulfuric acid and denox plant makes it possible to remove PM, NO_{X} and SO₂ without using water. The added benefit of not using limestone and making sulfuric acid instead of gypsum makes the water chemistry much simpler, because the pH of water is not affected by limestone and other contaminants. The resulting ash from the sulfuric acid process is water free and totally inert so that they can be disposed of safely.

Typically, the combustion temperature of the combustion unit is between about 1350° F. and about 1700° F.; and more preferably between about 1500° F. and about 1600° F.

### BRIEF DESCRIPTION OF THE DRAWINGS

Further aspects and advantages of the present invention will become better understood with reference to the description in association with the following Figures, in which:

FIG. 1 is a flow diagram showing a clean process for producing steam and/or power and using fuel from raw and/or preprocessed oil residues in accordance with an embodiment of the present invention; and

FIG. 2 is a schematic representation of a system of the present invention.

### DETAILED DESCRIPTION OF THE INVENTION

As used herein, the term “lower alkane” when used in connection with a solvent refers to a branched or straight chain acyclic alkyl group containing four to about ten carbon atoms, preferably four to about seven carbon atoms, and preferably five carbon atoms. Examples of suitable solvents include n-butane, iso-pentane, n-pentane, n-hexane, n-heptane, and mixtures thereof.

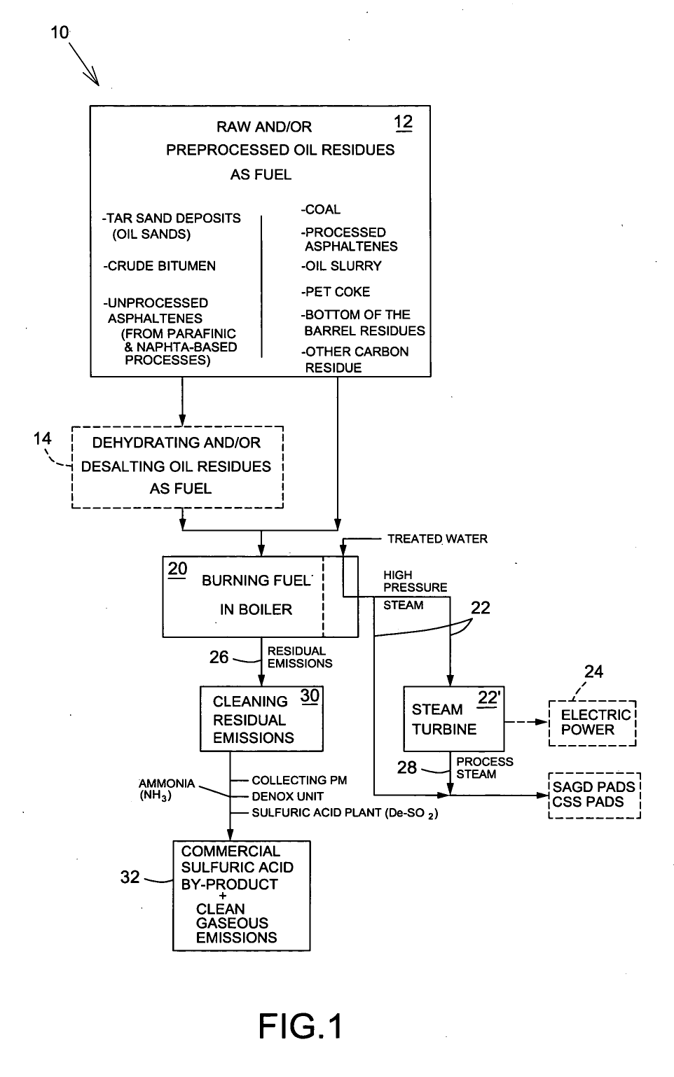

With reference to FIG. 1, there is shown a flow diagram of a clean process 10 for producing steam and/or power and using fuel from raw and/or preprocessed oil residues 12 in accordance with an embodiment of the present invention. Generally, the process 10 includes the steps of burning 20, or combusting, alone the oil residues 12 (without sorbents, solvents, diluents, reagents, surfactants or the like) as a fuel to generate high pressure steam 22 (from treated or distilled water), power 24 and residual emissions 26; and cleaning 30 the residual emissions 26 to generally and simultaneously remove PM (particulate materials), NO_{X} and SO₂ therefrom, filtering the PM, removing the NO_{X} using ammonia, and removing SO₂ to obtain liquid sulfuric acid. Simultaneously removing means, in the present invention, essentially at the same time in a continuous process (chemically in sequential order), in an essentially same location, or same plant or unit (not at different location on a same oil production site).

As an example, crude bitumen can come from many sources, examples of which include in situ SAGD (steam assisted gravity drainage) pads, surface mines. The present invention uses raw bitumen produced from either SAGD pads or CSS (cyclic steam stimulation) steam flooding or bitumen obtained from froth treatment at oil sands mines. Alternatively, the present invention uses coal, petroleum coke from stored pads or existing or future cokers located at upgraders or refinery sites, tar sand deposits, bottom of barrel residues, processed (water and salt free) and unprocessed asphaltenes, oil slurry, and the like carbon residues.

It is well known by those skilled in the art that crude bitumen removed from SAGD pads and the like contains water and salt which must be removed (as denoted by reference numeral 14 in FIG. 1) before further processing, as for any other similar oil residues when applicable. Many dehydration and desalting processes are known, such as that disclosed U.S. Pat. No. 6,536,523, the contents of which are hereby incorporated by reference. The salt content post desalting is typically 0.01% w/w.

In that example, the heavy oil or bitumen is flashed to remove the gas on fraction that will be mixed with the de-asphalted fraction. The residue will enter the de-asphalting step, the lower alkane solvents are mixed with the crude bitumen so that asphaltene precipitates and separates from de-asphalted oil (DAO). Typically, the solvents are used alone, but may be used as mixtures thereof.

The lower alkane solvents iso-pentane, n-pentane and hexane are usually selected, because during de-asphalting they are efficient at removing a large portion of the asphaltene and small portion of resin components, but do not remove all of the resin components, which are typically found in suspension, together with maltenes and aromatic compounds in the crude bitumen.

The portion of asphaltene separated is typically 10-20% w/w of crude bitumen, and the amount of precipitated resins is between 15 and 25% w/w of the total amount of the asphaltenes precipitated or 5-10% of w/w of the initial bitumen. Typically the amount of precipitated asphaltene is 15-20% w/w of the bitumen and more than 90% of the asphaltenes present in the crude oil. A small amount of resins will also be precipitated along with the asphaltenes.

For asphaltenes that are useful in roofing and the like, or indeed for transportation, a small amount of resin in the asphaltene is desirable. Therefore, a portion of the resin component may be co-precipitated with the asphaltene. Typically, the portion of the resin is less than 10% w/w. For co-precipitating the resin component, n-butane is typically the chosen lower alkane solvent, which is mixed with another of the lower alkane solvents.

Typically, the precipitation step takes place in a de-asphalting unit such as a ROSE™, SOLVAHL™, DEMEX™ or a similar unit, the operation of which is known to those skilled in the art.

Currently, the asphaltene exits the de-asphalting unit as a hot liquid and is fed to a combustion unit. In order, to ease handlability, the hot asphaltene can be pelletized or mixed with water to form an emulsion. Alternatively, hot asphaltene can also be mixed with dispersants and solvents to yield an oil-based emulsion.

In such cases, the combustion unit can be a standard Benson type boiler such as a once-through steam generator boiler (OTSG). More specialized combustion units include a circulating fluidized bed boiler (CFB), a bubbling fluid bed boiler (BFB) a fluidized bed boiler (FB) or an OTSG CFB boiler. Alternatively the combustion units can be a standard drum type of boiler that will produce 100% quality steam and cost less to purchase than OTSG (once through steam generating units). Water quality will be an issue that will be solved by using higher quality water treatments such as ZLD (zero liquid discharge) or other techniques known to the art.

Depending upon which combustion unit is chosen, a number of further processing steps can take place. With the Benson boiler, burning the asphaltene produces toxic flue gases such as sulfur dioxide. Typically, the Benson boiler or O.T.S.G. has a flue gas desulphurization (FGD) unit attached thereto which mixes the sulfur dioxide with hydrogen to produce less toxic hydrogen sulfide. Alternatively a scrubber unit may be use to remove sulfur. With fluidized bed boilers, limestone and lime may be added to produce commercially useful gypsum. Typically, the combustion units use available sources of fuel, such as petroleum coke or coal.

According to the present invention, the oil residues 12 are directly burned alone into any type of known boiler unit, without any chemical addition or the like, in the burning stage. The combustion temperature of the combustion unit 20 is typically between about 1350° F. and about 1700° F.; and more preferably between about 1500° F. and about 1600° F.

An important aspect of the present invention is the low cost generation of electricity for use on a site or for sale to the electricity grid. To this end, the invention provides a process for generating high pressure steam 22 from the boiler.

The steam 22 produced can be fed into a steam turbine 22′ to generate electrical power 24 to be sold to an electricity supplier or power grid. Alternatively, the process may be circular such that the steam 22 generated may be fed back into the SAGD pads to aid removal of bitumen therefrom. This could also be applicable to the back pressure process steam 28 coming out of the steam turbine 22′.

Another lower cost alternative to current limestone as sulfur sorbent consists, in the present invention, of using either standard boilers or fluidized bed boilers or any other boiler to burn the high sulfur fuel in the most efficient manner, and to connect the boiler to a sulfuric acid and denox plant 30 to clean up and remove the SO₂ and NO_{X} in the gas phase. The inventor found that removing the pollutants (SO₂, NO_{X}, PM) following combustion provides more flexibility, reduce emissions of SO₂, NO_{X} and PM (using high-efficiency fabric filter baghouse for example), and increased boiler efficiency by about 10-15% compared to others technologies. The high the sulfur content, the higher the efficiency improvement is.

The results of this alternative combustion process:
Low SO₂ emissions because up to 98%-99% of SO₂ is removed.
Low NO_{X} emissions because the low furnace temperature and combustion temperature plus the possible staging of air feed to the furnace produce very low NO_{X} emissions in a fluidized bed boiler. In addition the “denox” step removes 95% of NO_{X} when reacting with small quantities of added ammonia (NH₃).
High combustion efficiency in the furnace because the long solids residence time, even with fuels which are difficult to burn.
High thermal efficiency as sulphuric acid 32 production is exothermic to improve boiler efficiency (more SO₂, better efficiency).
As embodiment for this invention the combustion of asphaltenes and the sulphur contain therein, the following reactions occur when combustion of sulphur compound in a furnace equipped with sulfuric acid and denox plant 30.

Combustion: H₂S+3/2O₂→H₂O+SO₂+518 kJ/mole

Decomposition: H₂SO₄(liq.)+“HC”+O₂+q→SO₂+xCO₂+yH₂O

Oxidation: SO₂+1/2O₂→SO₃+99 kJ/mole

Hydration: SO₃+H₂O→H₂SO₄(gas)+101 kJ/mole

Condensation: H₂SO₄(gas)+0.17 H₂O(gas)→H₂SO₄(liq.)+69 kJ/mole

DENOX: NO+NH₃+1/2O₂→N₂+3/2H₂O+410 kJ/mole

The gas then enters the reactor, which contains one, two or more catalyst beds, depending on the SO₂ content and the desired degree of conversion. Since reaction in the reactor is endothermic the gas is cooled between the beds in order to favor the SO₂/SO₃ equilibrium. After the last conversion stage the gas is cooled, whereby the SO₃ reacts with the water vapor to form gas phase sulfuric acid as shown above.

In Northern Alberta the distances make transportation of limestone expensive and the production of gypsum and waste water problematic from an environmental point of view, which are not of concern with the present invention.

This invention allows the use of low cost fuels 12, to burn 20 in the most efficient manner, producing steam 22 and power 24 and meeting the most stringent emissions norms. A sulfuric acid and denox plant 30 helps reduce SO₂ by 99%, NO_{X} by 95-97% and PM by 99% (using high-efficiency fabric filter baghouse for example, or the like), and improves thermal efficiency from 34-36% to 41-44%, because production of sulfuric acid 32 is exothermic, as shown hereinabove.

Higher efficiency means reduced fuel use, and reduced emissions since less fuel is burned. In addition, the use of water is reduced to zero. The ashes are inert and do not interfere with the water chemistry of oil sands tailings.

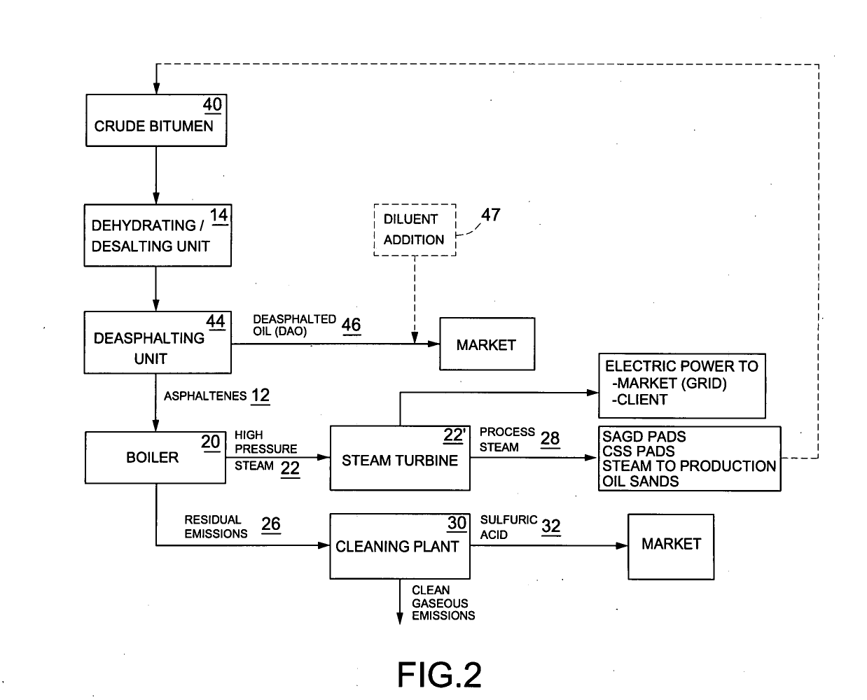

In another embodiment of the present invention, as illustrated in FIG. 2, there is provided an integrated system, typically applicable to SAGD, CSS & others steam injection or steam flooding processes, for carrying out the process 10 of the invention includes a well known dehydration/ desalting unit 14 for receiving the crude bitumen 40 from oil sands (water treatment and oil processing not detailed here), and dehydrating and desalting the oil sand before transporting to a de-asphalting unit 44. Optionally, if the oil sand is received from oil sand plants, it may already be dehydrated and desalted and thus may be fed directly into the de-asphalting unit. Typically, the de-asphalting unit 44 is a ROSE™ unit or other known commercial apparatus for de-asphalting oil using a lower alkane solvent or more typically a mixture of lower alkane solvents for precipitating a substantial portion of asphaltenes from unseparated bitumen. The deasphalted oil 46 is usable and returned to the oil market, with or without prior mixing with diluent(s) 47.

A combustion unit 20 in the form of a boiler such as described above burns the asphaltene 12 to generate high pressure steam 22, which may be fed to a steam turbine 22′. The process is cyclical and permits the steam turbine 22″ to pump process steam, or directly the high pressure steam, to be used into SAGD or CSS pads to remove crude bitumen 40 therefrom to begin the cycle again.

Residual emissions 26 are fed into a cleaning sulphuric acid and denox plant 30 to generally and simultaneously remove the PM, NO_{X} and SO₂ contaminants therefrom, and get commercial-grade generate sulfuric acid 32 as a by-product, along with clean gaseous emissions.

Contaminants such as nitrogen, sulfur, nickel, vanadium and Conradson carbon are reduced in the oil, which improves the value of the de-asphalted oil. De-asphalting the, dehydrated and desalted bitumen significantly reduces the use of diluents and thus the overall cost of processing is reduced. With this low cost carbon rejection method, the economics of bitumen production are greatly improved since both the use of expensive natural gas and expensive diluents are reduced dramatically.

I claim:

1. A clean process for producing steam and/or power and using fuel from raw and/or preprocessed oil residues, comprising the steps of:
(a) burning alone the oil residues as a fuel to generate high pressure steam, and/or power and residual emissions; and
(b) cleaning the residual emissions to generally and simultaneously remove PM, NO_{X} and SO₂ therefrom.

2. The process of claim 1, wherein in step (b), the residual emissions are processed through a cleaning unit including a sulfuric acid plant.

3. The process of claim 2, wherein in step (b), the cleaning unit includes a denox unit.

4. The process of claim 1, wherein in step (b), the cleaning removal process of PM, NO_{X} and SO₂ is water free.

5. The process of claim 1, wherein in step (a), the burning is performed at a temperature between about 1350° F. and about 1700° F.

6. The process of claim 5, wherein the burning is performed at a temperature between about 1500° F. and about 1600° F.

7. The process of claim 1, wherein the raw and/or preprocessed oil residues include crude oil and/or bitumen, the process further include, prior to the step (a), the step of de-hydrating and desalting the crude oil and/or bitumen.
